(19) United States
(12) Patent Application Publication
(10) Pub. No.: US 2013/0328829 A1
(43) Pub. Date: Dec. 12, 2013

(54) IN-CELL TOUCH DISPLAY PANEL SYSTEM WITH INCREASED ACCURACY OF TOUCH POSITIONS

(71) Applicant: SuperC-Touch Corporation, New Taipei City (TW)

(72) Inventor: Hsiang-Yu LEE, New Taipei City (TW)

(21) Appl. No.: 13/912,895

(22) Filed: Jun. 7, 2013

(30) Foreign Application Priority Data
Jun. 8, 2012 (TW) 101120666

(51) Int. Cl. G06F 3/041

(52) U.S. Cl. CPC G06F 3/0412
USPC 345/174

(57) ABSTRACT

An in-cell touch display panel system with increased accuracy of touch positions includes a panel display unit, a touch unit, a display unit power supply, and a touch unit power supply. The display unit power supply has a power supply end and a ground end for supplying power to the panel display unit. The touch unit power supply has a first switch, a second switch and an energy storage device. The first switch has one end connected to the power supply end and the other end connected to one end of the energy storage device. The second switch has one end connected to the ground end and the other end connected to the other end of the energy storage device. When the touch unit performs a touching detection, the first and second switches disconnect the energy storage device from the power supply end and the ground end.

### BACKGROUND OF THE INVENTION

1. Field of the Invention

The present invention relates to the technical of touch panels and, more particularly, to an in-cell touch display panel system with increased accuracy of touch positions.

2. Description of Related Art

A conventional touch display panel includes a touch panel and a display unit overlapped with the touch panel. The touch panel is configured as an operation interface. The touch panel is transparent so that an image generated by the display unit can be viewed directly by a user without being sheltered by the touch panel. Such well known skill of the touch panel may increase weight, thickness, reflectance and haze, and may further reduce light transmittance, so that the quality of screen display is greatly reduced.

On-cell and in-cell touch technologies were invented to overcome the drawbacks of traditional touch technology described above. The on-cell technology is to dispose a sensor on the back side of a color filter substrate to form a completed color filter substrate. One of the on-cell touch technologies is provided to dispose a touch sensor on a thin film and then bond the thin film onto the upper one of the two substrates.

The in-cell technology is to dispose the sensor within the LCD cell structure. Currently, there are three primary in-cell touch technologies, that are resistive, capacitive and optical touches, wherein the resistive touch technology employs two conductive substrates and the voltage variation of a common layer between the two substrates for determining a touch position on the touch display panel.

The in-cell touch technology is provided to integrate the touch sensor within the display unit so that the display unit itself has touch capabilities. Therefore, the touch display panel does not need to be bonded with an additional touch panel so as to simplify the assembly procedure. Such skill is generally developed by TFT LCD manufactures.

There is older touch control technology known as out-cell, which is typically applied to the resistive and capacitive touch panels. The out-cell touch technology is provided to add a touch module onto a display module. The touch module and the display module can be manufactured by the two separated parties.

However, for all the in-cell, on-cell and out-cell touch technologies, they all need a sensing layer to be configured on an upper or lower glass substrate, which not only increases the manufacturing cost but also complicates the manufacturing process, and which may also lower the aspect ratio and thus increase the strength of backlight, resulting in huge power consumption which is disadvantageous to make the mobile device compact.

To overcome this, a conventional skill is to implement a sensing electrode layer under a black matrix layer. FIG. 1 is a sectional view of an in-cell touch display panel structure 100 with a metal sensing layer. As shown in FIG. 1, the structure 100 includes a first substrate 110, a second substrate 120, a liquid crystal layer 130, a black matrix layer 140, a sensing electrode layer 150, a color filter 160, an overcoating layer 170, a common electrode layer (Vcom) 180, an upper polarizer 190, a lower polarizer 200, and a thin film transistor (TFT) layer 210.

FIG. 1 shows a schematic diagram only, not for the real dimension of the structure 100. In practical, the liquid crystal layer 130 may have a thickness of 5-10 μm, the upper polarizer 190 may have a thickness of 200 μm, the first substrate may have a thickness of 500 μm, and a distance from the black matrix 140 to the common electrode layer 180 is about 3-5 μm.

FIG. 2 is a schematic view of capacitance present with respect to the sensing electrode layer 150 when a finger touches. When the finger of a user touches on the upper polarizer 190, a distance from the finger to the sensing electrode layer 150 is about 700 μm (=200 μm+500 μm), and a distance from the sensing electrode layer 150 to the common electrode layer (Vcom) 180 is about 2-5 μm. Namely, the capacitance C1 generated between the finger and the sensing electrode layer 150 is significantly smaller than the capacitance C2 generated between the sensing electrode layer 150 and the common electrode layer (Vcom) 180. In this case, when the touch detection is performed through the sensing electrode layer 150 to calculate the coordinate of the touch position, the difference between the values obtained from different sensing electrodes becomes very small, which is disadvantageous to the coordinate calculation.

Therefore, it is desirable to provide an improved in-cell touch display panel system to mitigate and/or obviate the aforementioned problems.

### SUMMARY OF THE INVENTION

The object of the present invention is to provide an in-cell touch display panel system with increased accuracy of touch positions, which can effectively increase the accuracy of detected touch positions.

To achieve the object, the present invention provides an in-cell touch display panel system with increased accuracy of touch positions, which includes a panel display unit for displaying an image; a touch unit for performing a touch detection; a display unit power supply with a power supply end and a ground end for supplying power to the panel display unit; and a touch unit power supply including a first switch, a second switch, and an energy storage device, wherein the first switch has one end connected to the power supply end and the other end connected to one end of the energy storage device, and the second switch has one end connected to the ground end and the other end connected to the other end of the energy storage device, such that, when the touch unit performs the touching detection, the first switch disconnects the energy storage device from the power supply end while the second switch disconnects the energy storage device from the ground end.

Other objects, advantages, and novel features of the invention will become more apparent from the following detailed description when taken in conjunction with the accompanying drawings.

### BRIEF DESCRIPTION OF THE DRAWINGS

FIG. 1 is a sectional view of a typical in-cell touch display panel structure with a metal sensing layer;

FIG. 2 is a schematic view of capacitance present with respect to a sensing electrode layer when a finger touches in the prior art;

FIG. 3 is a block diagram of an in-cell touch display panel system with increased accuracy of touch positions according to the present invention;

FIG. 4 is a schematic view of a touch unit power supply according to the present invention;

FIG. 5 is a schematic view of sensing capacitance or stray capacitance in each layer when a finger touches according to the present invention;

FIG. 6 is a schematic view of a typical black matrix layer in the prior art;

FIG. 7 is a schematic view of a structure of a sensing electrode layer according to the present invention;

FIG. 8 is a schematic view of the black matrix layer and the sensing electrode layer according to the present invention;

FIG. 9 is another schematic view of sensing capacitance or stray capacitance in each layer when a finger touches according to the present invention; and

FIG. 10 is a schematic view of an equivalent capacitance according to the present invention.

### DETAILED DESCRIPTION OF THE PREFERRED EMBODIMENT

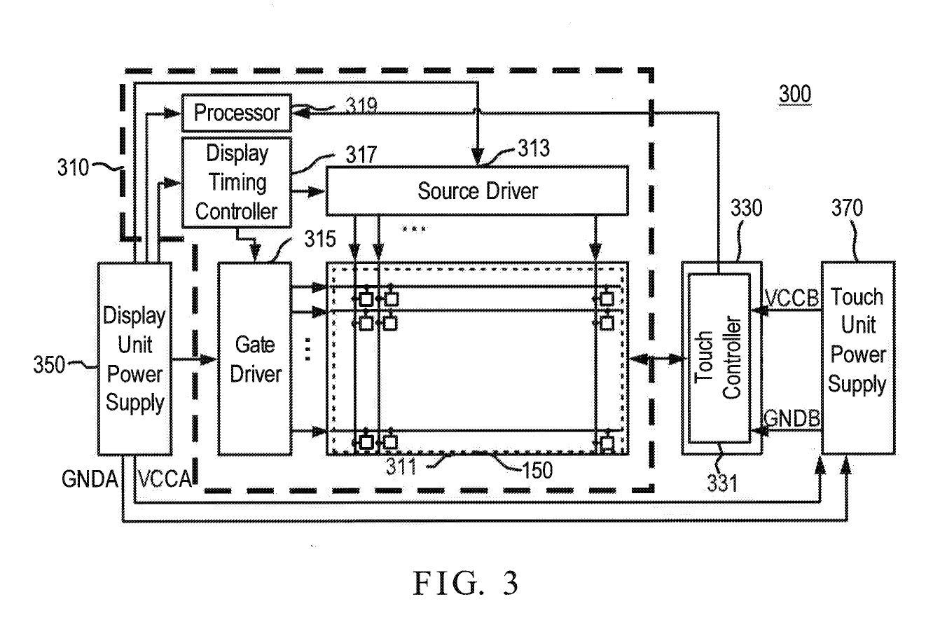

FIG. 3 is a block diagram of an in-cell touch display panel system 300 with increased accuracy of touch positions according to the present invention. The in-cell touch display panel system 300 includes a panel display unit 310, a touch unit 330, a display unit power supply 350, and a touch unit power supply 370.

The panel display unit 310 is provided for displaying an image. The touch unit 330 is provided for detecting a touch or performing a touch detection.

The display unit power supply 350 has a power supply end VCCA and a ground end GNDA for supplying power to the panel display unit 310.

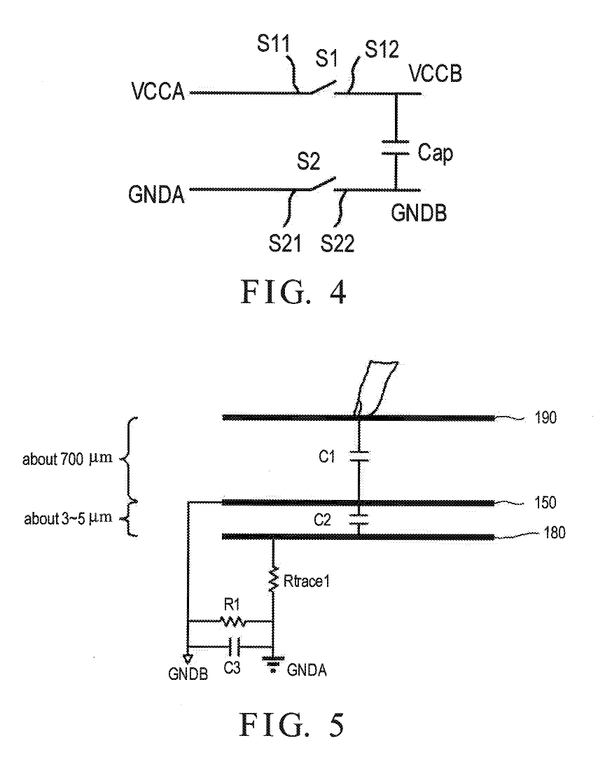

FIG. 4 is a schematic view of the touch unit power supply 370 according to the present invention. The touch-unit power supply 370 has a first switch S1, a second switch 52, and an energy storage device Cap. The first switch S1 has one end S11 connected to the power supply end VCCA and the other end S12 connected to one end VCCB of the energy storage device Cap. The second switch S2 has one end S21 connected to the ground end GNDA and the other end S22 connected to the other end GNDB of the energy storage device Cap. When the touch unit 330 performs a touching detection, the first switch S1 disconnects the energy storage device Cap from the power supply end VCCA while the second switch S2 disconnects the energy storage device Cap from the ground end GNDA. Preferably, the energy storage device is a capacitor.

FIG. 5 is a schematic view of sensing capacitance or stray capacitance in each layer when a finger touches according to the present invention. When the touch unit 330 performs a touching detection, the ground end GNDB of the energy storage device Cap is separated from the ground end GNDA since the first and the second switches S1 and S2 disconnect the energy storage device Cap from the power supply end VCCA and the ground end GNDA. Thus, there are a stray capacitance C3 and a resistance R1 between the ground end GNDB of the energy storage device Cap and the ground end GNDA. The resistance R1 is a very high resistance, indicating that the ground end GNDB of the energy storage device Cap is not conducted with the grounded end GNDA. The stray capacitance C3 is about 0.01-1 FF. The capacitance generated between the sensing electrode layer 150 and the common electrode layer (Vcom) 180 is about a few of 10s PF to a few of 100s PF. The capacitance C1 generated between the finger and the sensing electrode layer 150 is about 0.5-10 FF. When the stray capacitance C3 is connected in series with the stray capacitance C2, its equivalent capacitance is about 0.01-1 FF, which is equal to or smaller than the capacitance C1, so that the touch unit 330 is not interfered by the capacitance C2 when the touch detection is performed. Accordingly, the sensitivity of detecting a touch position is increased.

As shown in FIG. 3, the panel display unit 310 has a sensing display panel 311 with metal layer. The sensing display panel 311 with metal layer has a sensing electrode layer 150. The sensing electrode layer 150 is comprised of a plurality of sensing conductor lines to thereby form a plurality of touch electrodes.

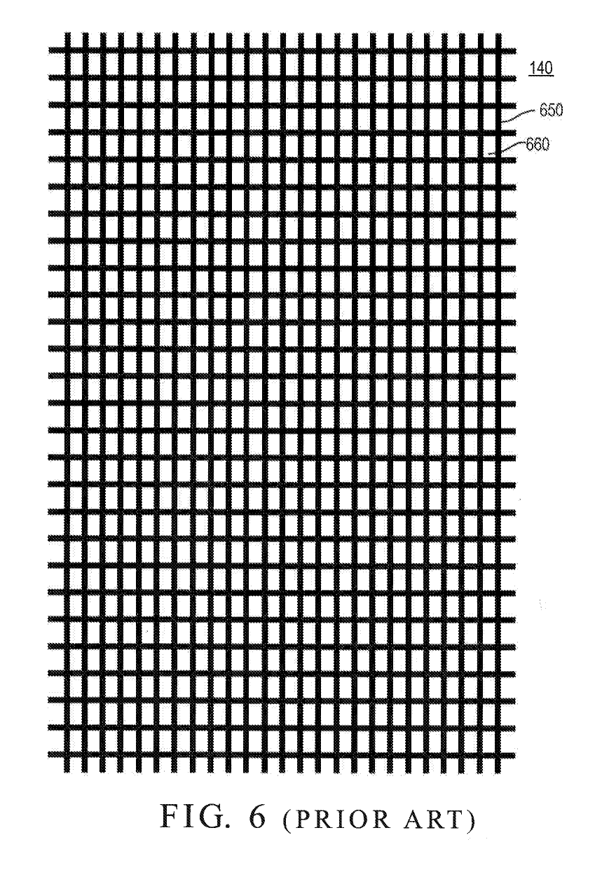

The sensing electrode layer 150 may have a structure as described in copending U.S. application Ser. No. 13/891,897 entitled “In-cell touch display panel structure with metal layer for sensing” filed on Mar. 12, 2013, the disclosure of which is incorporated herein by reference. FIG. 6 is a schematic view of a prior black matrix layer 140. As shown in FIG. 6, the prior black matrix layer 140 is comprised of plural lines 650 of insulating material that are black and opaque. The lines 650 of black insulating material are arranged as a checkerboard pattern and a color filter 660 is disposed among the lines of black insulating material.

A sensing electrode layer 150 is disposed between the black matrix layer 140 and the color filter 660, and a sensing touch pattern structure is formed on the sensing electrode layer 150, so that there is no need to arrange a sensing electrode layer over the upper or lower glass substrate of the LCD display panel.

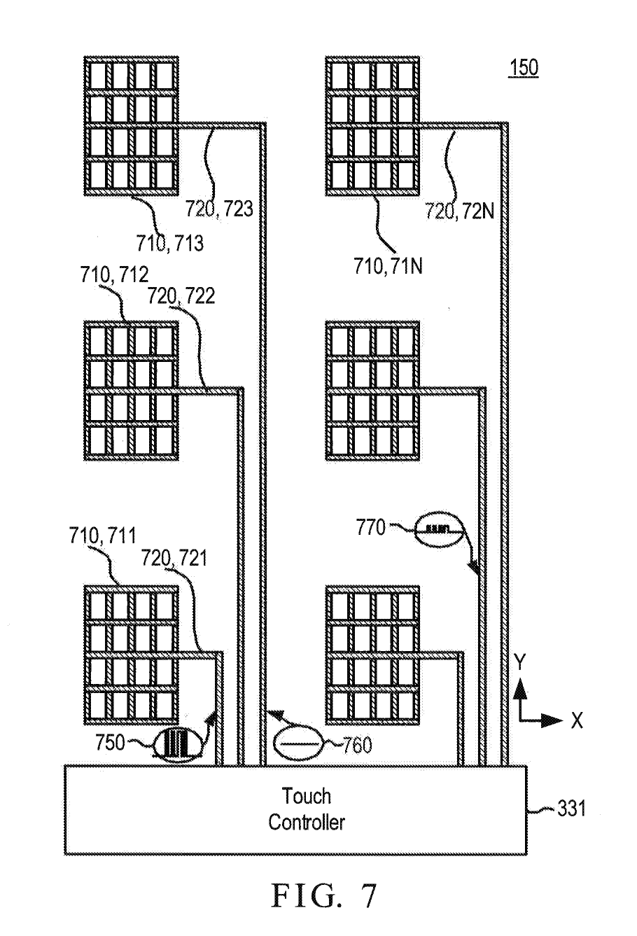

FIG. 7 is a schematic view of the structure of a sensing electrode layer described in the copending U.S. application Ser. No. 13/891,897. As shown in FIG. 7, the sensing electrode layer 150, that is disposed on one surface of the black matrix layer 140 facing the liquid crystal layer 130, is comprised of a plurality of sensing conductor lines 710, 720. The plurality of sensing conductor lines 710, 720 are disposed at positions corresponding to the positions of the plurality of opaque lines 650 of the black matrix layer 140.

As shown in FIG. 7, the sensing conductor lines 710, 720 of the sensing electrode layer 150 are arranged in a first direction (X-direction) and a second direction (Y-direction), wherein the first direction is vertical to the second direction. The sensing conductor lines 710, 720 of the sensing electrode layer 150 are made of conductive metal material or alloy material. The conductive metal material is selectively to be chromium, barium, and aluminum.

The sensing conductor lines 710, 720 are divided into a first group of sensing conductor lines 710 and a second group of sensing conductor lines 720. The first group of sensing conductor lines 710 is formed with N quadrilateral regions 711, 712, 713, . . . , 71N (711-71N), where N is an integer greater than one. The sensing conductor lines in any one of quadrilateral regions are electrically connected together, while the sensing conductor lines in any two quadrilateral regions are not electrically connected, so as to form a single-layered touch pattern on the sensing electrode layer 150.

Each of the quadrilateral regions 711-71N is formed in a rectangle, square, or rhombus shape. In this embodiment, each of the quadrilateral regions 711-71N is formed in a rectangle shape, and the sensing conductor lines are disposed at positions corresponding to the positions of the plurality of opaque lines 650 of the black matrix layer 140.

The second group of sensing conductor lines 720 is formed with N conductive traces 721, 722, 723, . . . , 72N (721-72N). Each of the N conductive traces 721-72N is electrically connected to a corresponding quadrilateral region 711-71N, while any two conductive traces 721-72N are not electrically connected.

Therefore, the first group of sensing conductor lines 710 and the second group of sensing conductor lines 720 form a plurality of touch electrodes 710, 720 in the sensing electrode layer 150 (i.e., one quadrilateral region 711-71N of the first group of sensing conductor lines 710 electrically connected with one conductive trace 721-72N of the second group of sensing conductor lines 720 is used as a touch electrode).

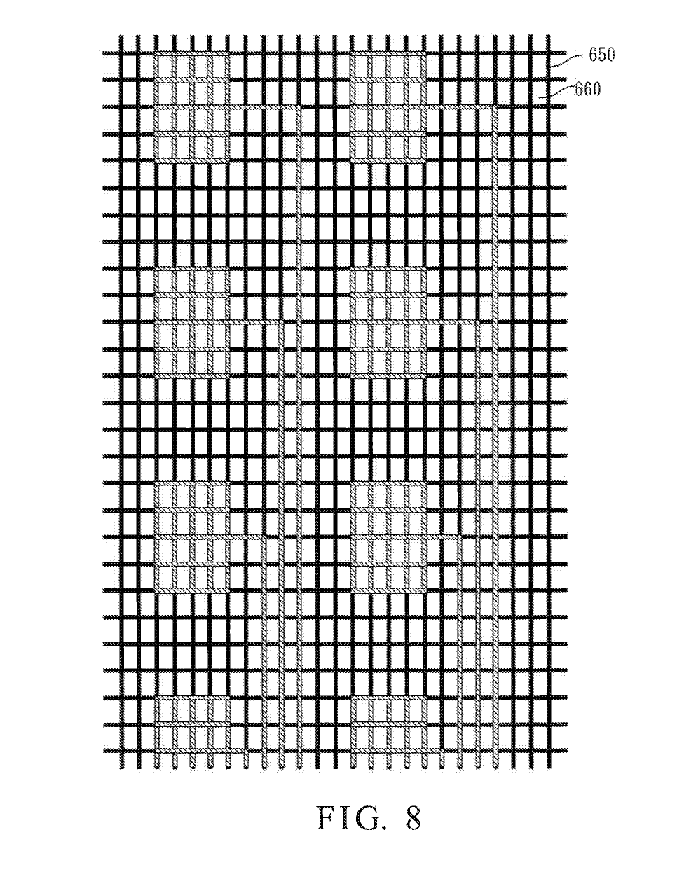

FIG. 8 is a schematic view of the black matrix layer 140 and the sensing electrode layer 150 according to the present invention. As shown, it schematically illustrates the black matrix layer 140 overlapped with the sensing electrode layer 150, viewing from the liquid crystal layer 130 to the first substrate 110.

The first group of sensing conductor lines 710 is correspondingly connected to the second group of sensing conductor lines 720. That is, the N conductive traces 711-71N are respectively connected to the N conductive traces 721-72N. Therefore, the first group of sensing conductor lines 710 can form a single-layered touch pattern on the sensing electrode layer 150. The line width of the first group of sensing conductor lines 710 or the second group of sensing conductor lines 720 is preferred to be smaller than or equal to the line width of the plurality of the opaque lines 650. When viewing from the first substrate 110 to the liquid crystal layer 130, the first group of sensing conductor lines 710 and the second group of sensing conductor lines 720 can be concealed by the plurality of opaque lines 650, so that users only see the plurality of opaque lines 650 but not the first group of sensing conductor lines 710 and the second group of sensing conductor lines 720.

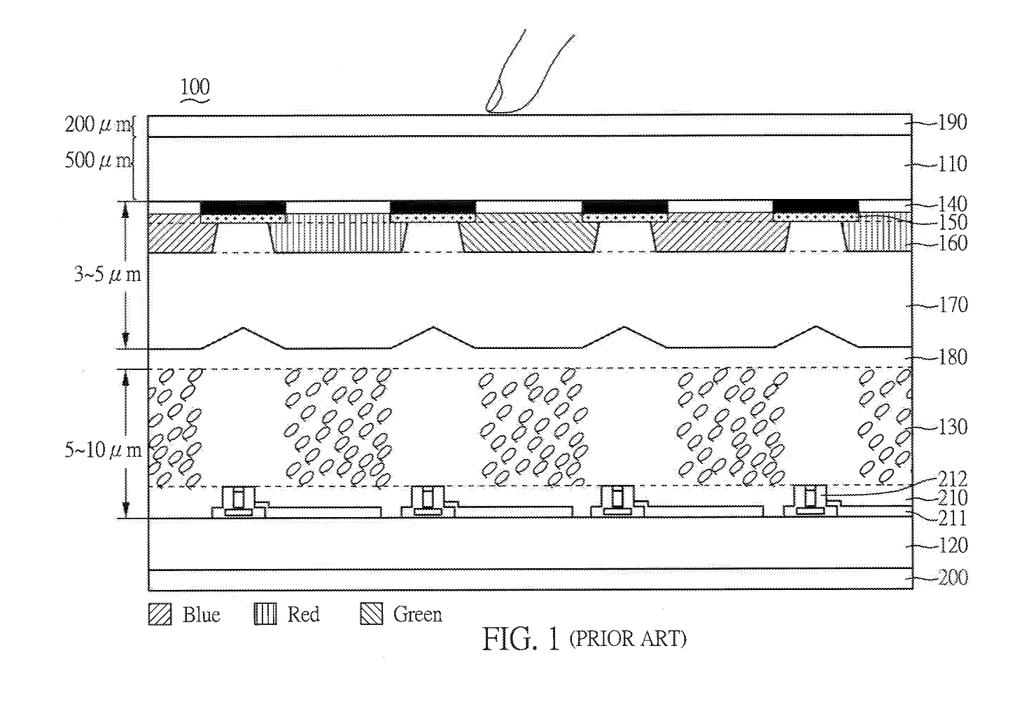

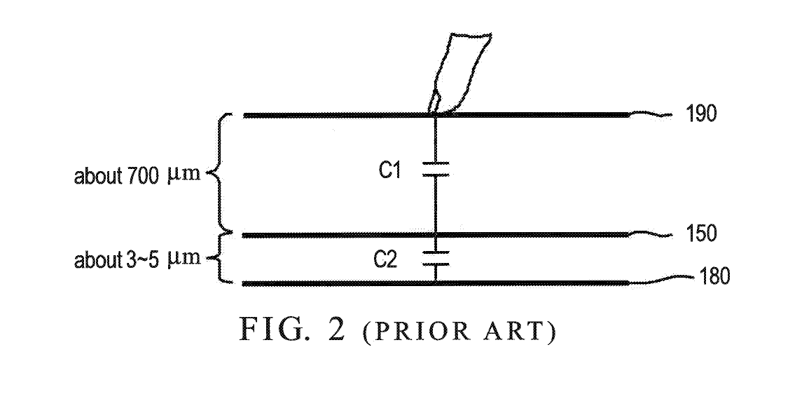

The sensing display panel 311 with metal layer has, as shown in FIG. 1, a first substrate 110, a second substrate 120, a liquid crystal layer 130, a black matrix layer 140, a sensing electrode layer 150, a color filter layer 160, an overcoat layer 170, a common electrode layer (Vcom) 180, an upper polarizer layer 190, a lower polarizer layer 200, and a thin film transistor (TFT) layer 210.

The first substrate 110 and the second substrate 120 are preferably glass substrates and are parallel to each other. The liquid crystal layer 130 is disposed between the first and second substrates 110, 120.

The black matrix layer 140 is between the first substrate 110 and the liquid crystal layer 130 and is disposed at one surface of the first substrate 110 that faces the liquid crystal layer 130. The black matrix layer 140 is composed of a plurality of opaque lines.

The color filter layer 160 is disposed among the plurality of sensing conductor lines 710, 720 of the sensing electrode layer 150 and on the surface of the plurality of sensing conductive lines 710, 720.

The overcoat layer 170 is disposed on the surface of the color filter layer 160.

The common electrode layer 180 is disposed between the first substrate 110 and the second substrate 120. For VA and TN type LCD, the common electrode layer 180 is disposed on the first substrate 110. For IPS and FFS type LCD, the common electrode layer 180 is disposed on the second substrate 120.

The upper polarizer layer 190 is disposed at one surface of the first substrate 110 opposite to the other surface of the first substrate 110 facing the liquid crystal layer 130.

The lower polarizer 200 is disposed at one surface of the second substrate 120 opposite to the other surface of the second substrate 120 facing the liquid crystal layer 130.

The TFT layer 210 is disposed at the surface of the second substrate 120 facing the liquid crystal layer 130. The TFT layer 210 is composed of TFTs 212 and transparent electrodes 211.

With reference to FIG. 3 again, the touch unit 330 has a touch controller 331 connected to the touch unit power supply 370 and the plurality of touch electrodes 710, 720 for sending a touch driving signal to the plurality of touch electrodes 710, 720 and detecting voltages of the touch electrodes 710, 720.

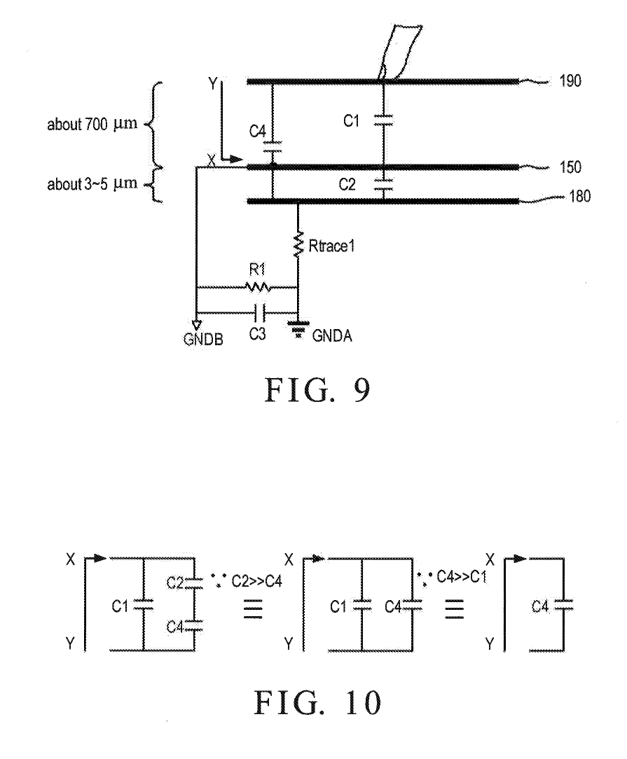

FIG. 9 is another schematic view of sensing capacitance or stray capacitance in each layer when a finger touches according to the present invention, wherein the capacitance C4 indicates a capacitance between the finger and the common electrode layer 180. The distance between the finger and the common electrode layer 180 is about 700 μm, but the capacitance C4 has a value greater than the capacitance C1 and smaller than the capacitance C2 since the area of the common electrode layer 180 is much greater than that of the touch electrodes 710, 720 of the sensing electrode layer 150. In addition, because the capacitance C3 has a very small value, it can be regarded as an open circuit, and in this case the equivalent capacitance seen at the ends X, Y is the capacitance C4. FIG. 10 is a schematic view of an equivalent capacitance according to the present invention. As can be seen, no matter which touch electrode 710, 720 is touched, the equivalent capacitance for proximity of each touch electrode 710, 720 is the capacitance C4, and the voltage measured by the touch controller 331 is similar, resulting in that a touch detection cannot be performed effectively.

To overcome this, when the touch driving signal is sent to one touch electrode 711, 721 (formed by quadrilateral region 711 electrically connected with conductive trace 721) of the plural touch electrodes 710, 720, the touch controller 331 in the present invention also sends a counteracting signal corresponding to the touch driving signal to the other touch electrodes. The counteracting signal is a ground signal or a signal with the same frequency but different amplitude than the touch driving signal.

As shown in FIG. 7, the touch controller 331 sends a ground signal 760 to the other touch electrodes to thereby ground the other touch electrodes and avoid them from being affected by the finger. Thus, the touching detection performed on the touch electrode 711, 721 is not affected. Likewise, when the touch driving signal 750 is sent to one touch electrode 711, 721 of the plural touch electrodes 710, 720, the touch controller 331 sends a counteracting signal 770 to the other touch electrodes, and in this case the counteracting signal is a signal with the same frequency but different amplitude than the touch driving signal 750.

As shown in FIG. 3, the panel display unit 310 of the in-cell touch display panel system 300 further includes a source driver 313, a gate driver 315, a display timing controller 317, and a processor 319.

The source driver 313 is connected to the sensing display panel 311 with metal layer in order to drive the metal sensing display panel 311 according to a display pixel signal.

The gate driver 315 is connected to the sensing display panel 311 with metal layer in order to generate a display driving signal to drive the sensing display panel 311 with metal layer.

The display timing controller 317 is connected to the source driver 313 and the gate driver 315 in order to provide a timing of the display pixel signal outputted by the source driver 313 and a timing of the display driving signal outputted by the gate driver 315.

The processor 319 is connected to the display timing controller 317 and the touch unit 330.

When the touch unit 330 performs a touching detection, a touch position data is obtained. The touch unit 330 sets the first switch S1 and the second switch S2 to be on, such that the energy storage device Cap is electrically connected to the power supply end VCCA and the ground end GNDA. Accordingly, the ground end GNDB of the energy storage device Cap is electrically connected to the ground end GNDA, so that the touch unit 330 can send the touch position data to the processor 319 for further processing.

As cited, a touch detection in the present invention is performed as the first and second switches S1, S2 are used to disconnect the energy storage device Cap from the power supply end VCCA and the ground end GNDA, so as to reduce the capacitance effect on the capacitance C2 formed between the sensing electrode layer 150 and the common electrode layer 180 and effectively increase the accuracy of detected touch positions. In addition, when the touch driving signal is sent to one touch electrode 711, 721, the touch controller 331 also sends a counteracting signal to the other touch electrodes so as to avoid the detection of the touch electrode 711, 721 from interference and further increase the accuracy of the detected touch positions.

Although the present invention has been explained in relation to its preferred embodiment, it is to be understood that many other possible modifications and variations can be made without departing from the spirit and scope of the invention as hereinafter claimed.

What is claimed is:

1. An in-cell touch display panel system with increased accuracy of touch positions, comprising:
a panel display unit for displaying an image;
a touch unit for performing a touch detection;
a display unit power supply with a power supply end and a ground end for supplying power to the panel display unit; and
a touch unit power supply including a first switch, a second switch, and an energy storage device, wherein the first switch has one end connected to the power supply end and the other end connected to one end of the energy storage device, and the second switch has one end connected to the ground end and the other end connected to the other end of the energy storage device, such that, when the touch unit performs the touching detection, the first switch disconnects the energy storage device from the power supply end while the second switch disconnects the energy storage device from the ground end.

2. The system as claimed in claim 1, wherein the panel display unit includes a sensing display panel with metal layer having an sensing electrode layer comprised of a plurality of sensing conductor lines so as to form a plurality of touch electrodes, and the touch unit has a touch controller connected to the touch unit power supply and the touch electrodes for sending touch driving signal to the touch electrodes and detecting voltages of the touch electrodes, and wherein, when the touch controller sends the touch driving signal to one of the touch electrodes, the touch controller also sends a counteracting signal corresponding to the touch driving signal to other touch electrodes.

3. The system as claimed in claim 2, wherein the counteracting signal is a ground signal.

4. The system as claimed in claim 2, wherein the counteracting signal is a signal with same frequency but different amplitude than the touch driving signal.

5. The system as claimed in claim 2, wherein the sensing display panel with metal layer comprises:
a first substrate;
a second substrate parallel to the first substrate;
a liquid crystal layer configured between the first substrate and the second substrates; and
a black matrix layer disposed at one surface of the first substrate facing the liquid crystal layer, the black matrix layer being composed of a plurality of opaque lines,
wherein the sensing electrode layer is disposed at one surface of the black matrix layer facing the liquid crystal layer, the plurality of sensing conductor lines of the sensing electrode layer is disposed corresponding to positions of the plurality of opaque lines of the black matrix layer.

6. The system as claimed in claim 5, wherein the plurality of sensing conductor lines are divided into a first group of sensing conductor lines and a second group of sensing conductor lines, the first group of sensing conductor lines being formed with N quadrilateral regions, where N is an integer greater than one, the sensing conductor lines in any one of the quadrilateral regions being electrically connected together while the sensing conductor lines in any two quadrilateral regions are not electrically connected, so as to form a single-layered touch pattern on the sensing electrode layer.

7. The system as claimed in claim 6, wherein the second group of sensing conductor lines is formed with N conductor traces, each of the N conductor traces being electrically connected to a corresponding quadrilateral region, while any two conductor traces are not electrically connected.

8. The system as claimed in claim 7, wherein the sensing conductor lines of the sensing electrode layer are arranged in a first direction and a second direction.

9. The system as claimed in claim 8, wherein the first direction is vertical to the second direction.

10. The system as claimed in claim 9, further comprising:
a color filter disposed among the sensing conductor lines of the sensing electrode layer and on the surface of the plurality of sensing conductor lines;
an overcoat layer disposed on a surface of the color filter;
a common electrode layer disposed between the first substrate and the second substrate; and
a thin film transistor layer disposed on a surface of the second substrate facing the liquid crystal layer.

11. The system as claimed in claim 10, wherein each of the quadrilateral regions is formed in a rectangle, square, or rhombus shape.

12. The system as claimed in claim 11, wherein the sensing conductor lines of the sensing electrode layer are made of conductive metal material or alloy material.

13. The system as claimed in claim 12, wherein the conductive metal material is selectively to be chromium, barium, and aluminum.

14. The system as claimed in claim 13, wherein the panel display unit further comprises:
a source driver connected to the sensing display panel with metal layer for driving the sensing display panel with metal layer according to a display pixel signal;
a gate driver connected to the sensing display panel with metal layer for generating a display driving signal to drive the sensing display panel with metal layer; and
a display timing controller connected to the source driver and the gate driver for providing a timing of the display pixel signal outputted by the source driver and a timing of the display driving signal outputted by the gate driver.
